(19) United States
(12) Patent Application Publication
(10) Pub. No.: US 2025/0210776 A1
(43) Pub. Date: Jun. 26, 2025

(54) BATTERY PACK AND A VEHICLE COMPRISING A BATTERY PACK

(71) Applicant: Scania CV AB, Södertälje (SE)

(72) Inventors: Alexei TSYCHKOV, Sollentuna (SE); Robin HELLSING, Eskilstuna (SE); Krister THOUR, Sköndal (SE); Kenneth PERSSON, Stenhamra (SE)

(73) Assignee: Scania CV AB, Södertälje (SE)

(21) Appl. No.: 18/850,094

(22) PCT Filed: Mar. 23, 2023
(86) PCT No.: PCT/SE2023/050261

§ 371 Date: Sep. 24, 2024

(30) Foreign Application Priority Data
Apr. 1, 2022 (SE) 2250414-6

(51) Int. Cl. H01M 50/249; B60L 50/64; H01M 10/42; H01M 50/204; H01M 50/296; H01M 50/507; H01M 50/583

(52) U.S. Cl. CPC H01M 50/249; B60L 50/64; H01M 10/425; H01M 50/204; H01M 50/296; H01M 50/507; H01M 50/583; H01M 2200/103; H01M 2220/20

(57) ABSTRACT

A battery pack is disclosed configured to provide electricity to an electric propulsion motor of a vehicle. The battery pack comprises at least two layers of battery cells arranged inside a casing, and a battery junction compartment arranged outside of the casing. The battery junction compartment comprises a number of electrical connection arrangements electrically connecting battery cells of the at least two layers of battery cells. The present disclosure further relates to a vehicle comprising an electric propulsion motor and a battery pack configured to provide electricity to the electric propulsion motor.

### TECHNICAL FIELD

The present disclosure relates to a battery pack configured to provide electricity to an electric propulsion motor of a vehicle. The present disclosure further relates to a vehicle comprising an electric propulsion motor configured to provide motive power to the vehicle and a battery pack configured to provide electricity to the electric propulsion motor.

### BACKGROUND

The use of electric drive for vehicles provides many advantages, especially regarding local emissions. Such vehicles comprise one or more electric propulsion motors configured to provide motive power to the vehicle. These types of vehicles can be divided into the categories pure electric vehicles and hybrid electric vehicles. Pure electric vehicles, sometimes referred to as battery electric vehicles, only-electric vehicles, and all-electric vehicles, comprise a pure electric powertrain and comprise no internal combustion engine and therefore produce no emissions in the place where they are used.

A hybrid electric vehicle comprises two or more distinct types of power, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating in pure electric drive when wanted, such as when driving in certain areas.

The electricity is usually stored in a battery pack comprising a number of rechargeable battery cells. Some different types of battery cells are used, such as lithium-ion battery cells, lithium polymer battery cells, as well as other types of rechargeable battery cells. One problem with battery packs is that the battery cells occupy space. Other problems are development costs, manufacturing costs, assembling costs, and difficulties in maintenance and repair of the battery packs.

A large number of battery cells is normally needed to ensure a sufficient available operational range of a vehicle, system voltage and power, especially in battery packs for heavier types of vehicles. A common packing solution is to arranged battery cells in modules each comprising a row of battery cells and arranging several modules side by side in several layers of modules inside a casing to thereby form a battery pack comprising several layers of battery cells inside the casing.

### SUMMARY

It is an object of the present invention to overcome, or at least alleviate, at least some of the above-mentioned problems and drawbacks.

According to a first aspect of the invention, the object is achieved by a battery pack configured to provide electricity to an electric propulsion motor of a vehicle, wherein the battery pack comprises at least two layers of battery cells arranged inside a casing and a battery junction compartment arranged outside of the casing. The battery junction compartment comprises a number of electrical connection arrangements electrically connecting battery cells of the at least two layers of battery cells.

Since the battery pack comprises the battery junction compartment arranged outside of the casing and since the battery junction compartment comprises the number of electrical connection arrangements electrically connecting battery cells of the at least two layers of battery cells, a battery pack is provided circumventing, or at least reducing, the need for electrical connection arrangements inside the casing of the battery pack for providing electrical connection of the at least two layers of battery cells.

Thereby, a battery pack is provided in which the available space inside the casing of the battery pack can be utilized in a more optimal manner for accommodating battery cells. In other words, due to these features, a larger proportion of the available space inside the casing of the battery pack can be utilized for accommodating battery cells.

Moreover, since the battery pack comprises the battery junction compartment arranged outside of the casing and since the battery junction compartment comprises the number of electrical connection arrangements, a battery pack is provided having conditions for a simpler and more efficient manufacture and assembly of the battery pack. This is because the layers of battery cells can be electrically connected in a quick and simple manner inside the battery junction compartment instead of inside the casing of the battery pack.

Moreover, the routing of electrical conductors, such as cables, inside the respective layer of battery cells may be facilitated. In addition, a battery pack is provided having conditions for a simplified maintenance, repair, and replacements of components because the electrical connection arrangements can be accessed in the battery junction compartment instead of inside the casing of the battery pack.

In addition, a safer battery pack can be provided because conditions are provided for a significantly simplified manual disconnection of the electrical contact between the layers of battery cells in the battery junction compartment, as compared to prior art solutions in which layers of battery cells are electrically connected to each other by electrical connection arrangements arranged inside the casing of the battery pack.

Furthermore, due to the features of the battery pack, conditions are provided for several variants of battery pack of different sizes and/or configurations in which different numbers of layers of battery cells can be electrically connected via a standardized battery junction compartment. In other words, the battery pack according to the embodiments herein allows different variants of battery packs of different sizes and/or configurations to be provided at lower development costs.

Moreover, a battery pack is provided having conditions and characteristics suitable for being manufactured and assembled in a cost-efficient manner because the layers of battery cells of the battery pack can be electrically connected in a quicker and simpler manner inside the battery junction compartment instead of inside the casing of the battery pack.

Accordingly, a battery pack is provided overcoming, or at least alleviating, at least some of the above-mentioned problems and drawbacks. As a result, the above-mentioned object is achieved.

Optionally, the battery junction compartment comprises a compartment body forming an opening and an inner space accommodating the number of electrical connection arrangements and a lid arrangeable to cover the opening and removable to provide access to the inner space of battery junction compartment via the opening. Thereby, a battery pack is provided significantly facilitating maintenance, service, repair, and replacements of components of the battery pack. Furthermore, a battery pack is provided conditions and characteristics suitable for being manufactured and assembled in a cost-efficient manner. This is because the layers of battery cells of the battery pack can be electrically connected in a quick and simple manner inside the battery junction compartment and the inner space of the battery junction compartment can be sealed from the outside environment simply by arranging the lid to cover the opening. In addition, a safer battery pack can be provided because conditions are provided for a significantly simplified manual disconnection of the electrical contact between the layers of battery cells in the battery junction compartment.

Optionally, the number of electrical connection arrangements comprises at least one electrical connector removably arranged via an attachment assembly. Thereby, a safer battery pack can be provided because the layers of battery cells can be electrically disconnected from each other simply by removing the at least one electrical connector at the attachment assembly.

Optionally, the attachment assembly is accessible via the opening when the lid is removed from the opening. Thereby, a battery pack is provided allowing a quicker manual disconnection of the electrical contact between the layers of battery cells simply by removing the lid and removing the at least one electrical connector at the attachment assembly.

Optionally, the number of electrical connection arrangements comprises one or more of a battery fuse and a contactor. Thereby, a battery pack is provided significantly facilitating maintenance, service, repair, and replacements of components of the battery pack. This is because each of a battery fuse and a contactor is a type of component which may require service, repair, and/or replacement at an earlier time than the battery cells of the battery pack. Accordingly, due to these features, instead of performing a disassembly of the entire battery pack, the battery fuse and/or the contactor can be accessed inside the battery junction compartment.

Optionally, the battery junction compartment comprises a component cluster unit comprising at least part of the number of electrical connection arrangements. Thereby, by arranging at least part of the number of electrical connection arrangements in a component cluster unit, conditions are provided for several variants of battery pack of different sizes and/or configurations in which different numbers of layers of battery cells can be electrically connected via a standardized component cluster unit. In other words, the battery pack according to the embodiments herein allows different variants of battery packs of different sizes and/or configurations to be provided at lower development costs. Moreover, a battery pack is provided having conditions and characteristics suitable for being manufactured and assembled in a cost-efficient manner because the layers of battery cells of the battery pack can be electrically connected in a quicker and simpler manner via the component cluster unit.

Optionally, the component cluster unit further comprises a battery control arrangement. Thereby, a component cluster unit is provided capable of performing several functions while being able to electrically connect layers of battery cells of the battery pack. Moreover, a battery pack is provided facilitating maintenance, service, repair, and replacements of components of the battery pack.

Optionally, the battery junction compartment comprises a compartment body forming an opening and an inner space accommodating the number of electrical connection arrangements, wherein the component cluster unit is assembled inside the inner space by an insertion of the component cluster unit through the opening along a determined insertion direction, and wherein the component cluster unit is secured to the compartment body in directions parallel to the determined insertion direction by a number of fastening elements. Thereby, a battery pack is provided having conditions and characteristics suitable for being manufactured and assembled in a cost-efficient manner. This is because an assembler, or an assembling machine, can assemble the component cluster unit inside the inner space by inserting the component cluster unit through the opening along the determined insertion direction, and then securing the component cluster unit to the compartment body by attaching the number of fastening elements.

Furthermore, a battery pack is provided significantly facilitating maintenance, service, repair, and replacements of components of the battery pack. This is because the component cluster unit can be removed from the battery junction compartment in a simple and quick manner simply by detaching the number of fastening elements and removing the component cluster unit through the opening along a direction opposite to the determined insertion direction.

Optionally, the component cluster unit comprises a unit body, and wherein the component cluster unit is secured relative to the compartment body in directions transversal to the determined insertion direction by an abutting contact between the unit body and the compartment body. Thereby, the need for further fastening elements than the number of fastening elements securing the component cluster unit to the compartment body in directions parallel to the determined insertion direction is circumvented. As a result, a battery pack is provided having conditions and characteristics suitable for being manufactured and assembled in a cost-efficient manner. Moreover, a battery pack is provided significantly facilitating maintenance, service, repair, and replacements of components of the battery pack.

Optionally, the battery junction compartment comprises one component cluster unit per pair of layers of battery cells of the battery pack, and wherein each component cluster unit comprises electrical connection arrangements electrically connecting battery cells of one pair of layers of battery cells. Thereby, conditions are provided for several variants of battery pack of different sizes and/or configurations in which different numbers of layers of battery cells can be electrically connected via a standardized component cluster unit. In other words, the battery pack according to the embodiments herein allows different variants of battery packs of different sizes and/or configurations to be provided at lower development costs. Moreover, a battery pack is provided having conditions and characteristics suitable for being manufactured and assembled in a cost-efficient manner because the layers of battery cells of the battery pack can be electrically connected in a quicker and simpler manner via a standardized component cluster unit.

Optionally, the battery pack comprises at least four layers of battery cells, and wherein the battery junction compartment comprises a first component cluster unit comprising electrical connection arrangements electrically connecting battery cells of a first pair of layers of battery cells, and a second component cluster unit comprising electrical connection arrangements electrically connecting battery cells of a second pair of layers of battery cells. Thereby, a battery pack is provided having conditions and characteristics suitable for being manufactured and assembled in a cost-efficient manner. This is because the at least four layers of battery cells of the battery pack can be electrically connected via the first and second component cluster units.

Optionally, the second component cluster unit has the same design, layout, and types of components as the first component cluster unit. Thereby, a battery pack is provided having conditions and characteristics suitable for being manufactured and assembled in a cost-efficient manner. This is because a first and second component cluster unit of identical design can be utilized to electrically connect the at least four layers of battery cells of the battery pack. As a further result thereof, the battery pack allows different variants of battery packs of different sizes and/or configurations to be provided at lower development costs.

Optionally, the battery junction compartment comprises one aperture per layer of battery cells, and wherein each aperture accommodates an electrical conductor to a layer of battery cells. Thereby, a simple, efficient, and reliable electrical connection of battery cells of the battery pack can be provided.

Optionally, the casing comprises one aperture per layer of battery cells for routing of an electrical conductor between a layer of battery cells and the battery junction compartment. Thereby, a simple, efficient, and reliable routing of electrical conductors and electrical connection of battery cells of the battery pack can be provided.

Optionally, each layer of battery cells comprises a number of battery modules arranged adjacent to each other, and wherein each module comprises one row of battery cells.

Thereby, a space efficient battery pack is provided having conditions and characteristics suitable for being manufactured and assembled in a cost-efficient manner.

Optionally, the battery junction compartment comprises a high voltage connection arrangement for connecting the layers of battery cells to an electric system of the vehicle. Thereby, the layers of battery cells of the battery pack can be electrically connected to, and disconnected from, the electric system of the vehicle in a quick and simple manner.

According to a second aspect of the invention, the object is achieved by a vehicle comprising an electric propulsion motor configured to provide motive power to the vehicle, and wherein the vehicle comprises a battery pack according to some embodiments of the present disclosure, and wherein the battery pack is configured to provide electricity to the electric propulsion motor.

Since the vehicle comprises a battery pack according to some embodiments, a vehicle is provided comprising a battery pack circumventing the need for an electrical connection of the at least two layers of battery cells inside the casing of the battery pack. Thereby, the available space inside the casing of the battery pack can be utilized in a more optimal manner for accommodating battery cells. In other words, due to these features, a larger proportion of the available space inside the casing of the battery pack can be utilized for accommodating battery cells.

Moreover, a vehicle is provided having conditions for a simplified maintenance, repair, and replacements of components of the battery pack. In addition, a vehicle is provided having conditions for a significantly simplified manual disconnection of the electrical contact between the layers of battery cells in the battery junction compartment of the battery pack.

Furthermore, a vehicle is provided comprising a battery pack having conditions and characteristics suitable for being manufactured and assembled in a cost-efficient manner.

Accordingly, a vehicle is provided overcoming, or at least alleviating, at least some of the above-mentioned problems and drawbacks. As a result, the above-mentioned object is achieved.

Optionally, the battery pack is attached to the vehicle such that the battery junction compartment of the battery pack can be accessed from an outside of the vehicle. Thereby, a vehicle is provided in which maintenance, service, repair, and replacements of components of the battery pack is significantly facilitated. Furthermore, since the battery junction compartment of the battery pack can be accessed from an outside of the vehicle, a safer vehicle can be provided.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a vehicle according to some embodiments of the present disclosure,

FIG. 2 schematically illustrates a battery pack of the vehicle illustrated in FIG. 1,

FIG. 3 schematically illustrates a battery pack according to some further embodiments,

FIG. 4 schematically illustrates a battery pack according to some further embodiments,

FIG. 5 schematically illustrates a perspective view of a first casing layer of the battery pack according to the embodiments illustrated in FIG. 2 and FIG. 3,

FIG. 6a schematically illustrates a battery junction compartment of the battery pack according to the embodiments illustrated in FIG. 3 and FIG. 4,

FIG. 6b schematically illustrates a compartment body and a component cluster unit of the battery junction compartment illustrated in FIG. 6a,

FIG. 7a schematically illustrates a battery junction compartment of the battery pack according to the embodiments illustrated in FIG. 2, and

FIG. 7b schematically illustrates a compartment body and a first and a second component cluster unit of the battery junction compartment illustrated in FIG. 7a.

### DETAILED DESCRIPTION

Aspects of the present invention will now be described more fully. Like numbers refer to like elements throughout. Well-known functions or constructions will not necessarily be described in detail for brevity and/or clarity.

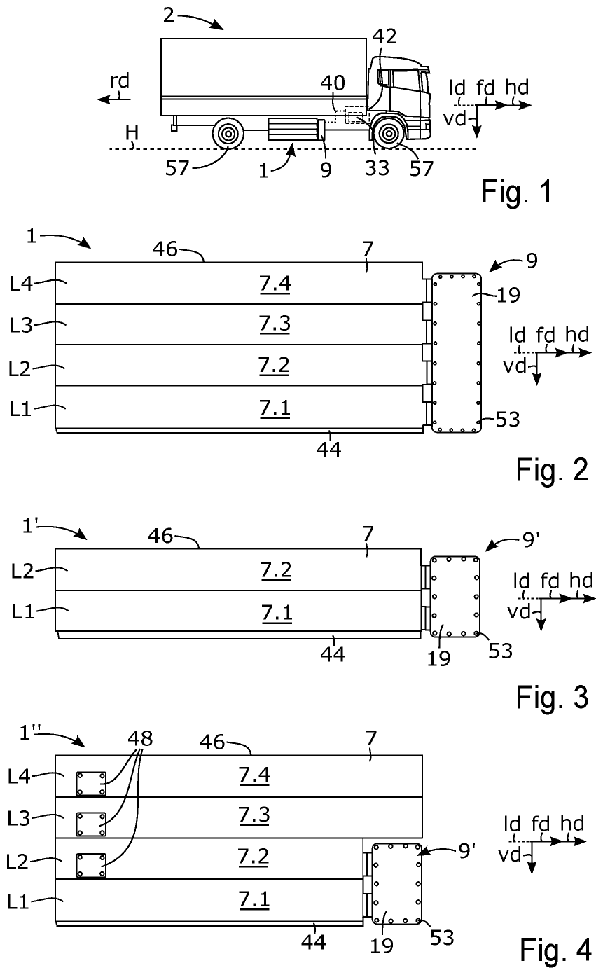

FIG. 1 schematically illustrates a vehicle 2, according to some embodiments of the present disclosure. According to the illustrated embodiments, the vehicle 2 is a truck, i.e., a type of heavy vehicle. According to further embodiments, the vehicle 2, as referred to herein, may be another type of heavy or lighter type of manned or unmanned vehicle for land or water-based propulsion such as a lorry, a bus, a construction vehicle, a tractor, a car, a ship, a boat, or the like.

The vehicle 2 comprises an electric powertrain 42. According to the illustrated embodiments, the electric powertrain 42 is configured to provide motive power to the vehicle 2 via wheels 57 of the vehicle 2. The electric powertrain 42 comprises an electric propulsion motor 33. The electric propulsion motor 33 is capable of providing motive power to the vehicle 2 via wheels 57 of the vehicle 2 as well as providing regenerative braking of the vehicle 2. Thus, according to the illustrated embodiments, the electric propulsion motor 33 is capable of operating as an electric motor as well as an electric generator. The electric propulsion motor 33 of the vehicle 2 may also be referred to as a vehicle propulsion motor/generator.

According to the illustrated embodiments, the electric powertrain 42 of the vehicle 2 is a pure electric powertrain 42, i.e., a powertrain comprising no internal combustion engine. According to further embodiments, the electric powertrain 42 of the vehicle 2 may be a so-called hybrid electric powertrain 42 comprising a combustion engine in addition to the electric propulsion motor 33 for providing motive power to the vehicle 2.

Moreover, as is indicated in FIG. 1, the vehicle 2 comprises a battery pack 1 and an electric system 40. The battery pack 1 is operably connected to the electric propulsion motor 33 via the electric system 40. In other words, the battery pack 1 is configured to provide electricity to the electric propulsion motor 33 via the electric system 40. Moreover, according to the illustrated embodiments, the battery pack 1 is configured to receive electricity from the electric propulsion motor 33 via the electric system 40 during regenerative braking of the vehicle 2. As is further explained herein, the battery pack 1 comprises a number of battery cells. In FIG. 1, the vehicle 2 is illustrated as comprising one battery pack 1. However, the vehicle 2 may comprise more than one battery pack 1.

In FIG. 1, the vehicle 2 is illustrated as positioned onto a flat horizontal surface H in an intended use position. Moreover, in FIG. 1, a vertical direction vd of the vehicle 2 is indicated. The vertical direction vd of the vehicle 2 is perpendicular to the flat horizontal surface H when the vehicle 2 is positioned thereon in the intended use position. Moreover, the vertical direction vd of the vehicle 2 coincides with a local gravity vector at the location of the vehicle 2 when the vehicle 2 positioned onto a flat horizontal surface H in an intended use position.

In FIG. 1, a horizontal direction hd of the vehicle 2 is indicated. The horizontal direction hd of the vehicle 2 is parallel to the flat horizontal surface H when the vehicle 2 is positioned thereon in the intended use position.

As can be seen in FIG. 1, the wheels 57 of the vehicle 2 are abutting the flat horizontal surface Hs when the vehicle 2 is positioned in the intended upright use position on the flat horizontal surface Hs. The vehicle 2 has a longitudinal direction ld. The longitudinal direction ld of the vehicle 2 is parallel to the flat horizontal surface Hs when the vehicle 2 is positioned in the intended upright use position thereon. Moreover, the longitudinal direction ld of the vehicle 2 is parallel to a forward moving direction fd of the vehicle 2 as well as to a reverse moving direction rd of the vehicle 2. The reverse moving direction rd of the vehicle 2 is opposite to the forward moving direction fd of the vehicle 2.

FIG. 2 schematically illustrates the battery pack 1 of the vehicle 2 illustrated in FIG. 1. The battery pack 1 comprises a casing 7 and a number of layers L1, L2, L3, L4 of battery cells arranged inside the casing 7. The reference sign for the layers L1, L2, L3, L4 of battery cells is abbreviated “L1-L4” in some places herein for reasons of brevity and clarity. According to the embodiments illustrated in FIG. 2, the battery pack 1 comprises four layers L1-L4 of battery cells arranged inside the casing 7. As is further explained herein, the battery pack 1 may comprise another number of layers L1-L4 of battery cells arranged inside the casing 7, such as a number between two and twelve, or a number between two and eight.

The casing 7 forms a protective outer shell for battery cells inside the casing 7. As is further explained herein, according to the illustrated embodiments, each layer L1-L4 of battery cells comprises a number of battery modules, wherein each battery module comprises a number of battery cells arranged in rows. Thus, according to the illustrated embodiments, the casing 7 is configured to support these battery modules.

According to the illustrated embodiments, the casing 7 is formed by a number of casing sections 7.1, 7.2, 7.3, 7.4. The reference sign for the casing sections 7.1, 7.2, 7.3, 7.4 of the casing 7 is abbreviated “7.1-7.4” in some places herein for reasons of brevity and clarity. According to the illustrated embodiments, each casing section 7.1-7.4 is configured to accommodate one layer L1-L4 of battery cells. In other words, the battery pack 1 comprises the same number of casing sections 7.1-7.4 as the number of layers L1-L4 of battery cells of the battery pack 1. According to the illustrated embodiments, two adjacent casing sections 7.1-7.4 of the number of casing sections 7.1-7.4 are attached to each other via a number of fastening elements.

The battery pack 1 comprises a battery junction compartment 9. The battery junction compartment 9 is arranged outside of the casing 7. The feature that the battery junction compartment 9 is arranged outside of the casing 7 means that the battery junction compartment 9 is arranged outside of a volume enclosed by the casing 7 and/or by the casing sections 7.1-7.4 thereof. The battery junction compartment 9 may also be referred to as a battery junction box, or the like.

As is further explained herein, the battery junction compartment 9 comprises a number of electrical connection arrangements electrically connecting battery cells of at least two layers L1-L4 of battery cells of the battery pack 1. According to the embodiments illustrated in FIG. 2, the electrical connection arrangements of the battery junction compartment 9 is configured electrically connect battery cells of all layers L1-L4 of battery cells of the battery pack 1, namely the four layers L1-L4 of battery cells of the battery pack 1, as is further explained herein.

FIG. 3 schematically illustrates a battery pack 1′ according to some further embodiments. The vehicle 2 illustrated in FIG. 1 may comprise one or more battery packs 1′ according to the embodiments illustrated in FIG. 3. The battery pack 1′ according to the embodiments illustrated in FIG. 3 comprises two layers L1, L2 of battery cells arranged inside a casing 7.

The casing 7 forms a protective outer shell for battery cells inside the casing. As is further explained herein, according to the illustrated embodiments, each layer L1, L2 of battery cells comprises a number of battery modules, wherein each battery module comprises a number of battery cells arranged in rows. Thus, according to the illustrated embodiments, the casing 7 is configured to support these battery modules.

Like the embodiments illustrated in FIG. 2, the casing 7 is formed by a number of casing sections 7.1, 7.2 attached to each other via a number of fastening elements, wherein each casing section 7.1-7.2 is configured to accommodate one layer L1, L2 of battery cells.

According to the embodiments illustrated in FIG. 3, a first casing section 7.1 and a first layer L1 of battery cells of the battery pack 1′ may each be identical to a first casing section 7.1 and a first layer L1 of battery cells of the battery pack 1 according to the embodiments illustrated in FIG. 2. Moreover, a second casing section 7.2 and a second layer L2 of battery cells of the battery pack 1′ illustrated in FIG. 3 may each be identical to a fourth casing section 7.4 and a fourth layer L4 of battery cells of the battery pack 1 according to the embodiments illustrated in FIG. 2.

In FIG. 2 and FIG. 3, the vertical direction vd, the longitudinal direction ld, and the horizontal direction hd of the vehicle 2 illustrated in FIG. 1 are indicated. The respective battery pack 1, 1′ are illustrated in an intended mounting orientation relative to these directions vd, ld, hd in FIG. 2 and FIG. 3.

As seen in FIG. 2 and FIG. 3, the layers L1-L4 of battery cells, as well as the casing sections 7.1-7.4, of the battery packs 1, 1′ have greater dimensions measured in directions parallel to the horizontal direction hd than the dimensions measured in directions parallel to the vertical direction vd. Moreover, the layers L1-L4 of battery cells, as well as the casing sections 7.1-7.4, of the battery packs 1, 1′ are stacked on top of each other along the vertical direction vd.

The first layer L1 of battery cells and a first casing section 7.1 of the battery pack 1 illustrated in FIG. 2, and of the battery pack 1′ illustrated in FIG. 3, can be said to constitute a bottom layer of battery cells and a bottom casing section of the casing 7, because these layer of battery cells/casing sections will be closest to the horizontal surface H indicated in FIG. 1, when the battery pack 1, 1′ is mounted to a vehicle 2 and the vehicle 2 is positioned in an upright use position on the horizontal surface H. As indicated in FIG. 2 and FIG. 3, the first casing section 7.1 of the respective battery pack 1, 1′ may comprise a bottom cover 44.

Likewise, the fourth layer L4 of battery cells and a fourth casing section 7.4 of the battery pack 1 illustrated in FIG. 2, and the second layer L2 of battery cells and a second casing section 7.2 of the battery pack 1′ illustrated in FIG. 3, can be said to constitute a top layer of battery cells and a top casing section of the casing 7, because these layer of battery cells/casing sections will be furthest from the horizontal surface H indicated in FIG. 1, when the battery pack 1, 1′ is mounted to a vehicle 2 and the vehicle 2 is positioned in an upright use position on the horizontal surface H. As indicated in FIG. 2 and FIG. 3, the fourth casing section 7.4 of the battery pack 1 illustrated in FIG. 2 and the second casing section 7.2 of the battery pack 1′ illustrated in FIG. 3, may each comprise a top cover 46.

The battery pack 1′ illustrated in FIG. 3 comprises a battery junction compartment 9′. The battery junction compartment 9′ is arranged outside of the casing 7. The feature that the battery junction compartment 9′ is arranged outside of the casing 7 means that the battery junction compartment 9′ is arranged outside of a volume enclosed by the casing 7 and/or by the casing sections 7.1, 7.2 thereof. The battery junction compartment 9′ may also be referred to as a battery junction box, or the like. As is further explained herein, the battery junction compartment 9′ comprises a number of electrical connection arrangements electrically connecting battery cells of the layers L1, L2 of battery cells of the battery pack 1′, i.e., the two layers L1, L2 of battery cells of the battery pack 1′.

FIG. 4 schematically illustrates a battery pack 1″ according to some further embodiments. The vehicle 2 illustrated in FIG. 1 may comprise one or more battery packs 1″ according to the embodiments illustrated in FIG. 3. The battery pack 1″ according to the embodiments illustrated in FIG. 3 comprises four layers L1, L2, L3, L4 of battery cells arranged inside a casing 7.

The casing 7 forms a protective outer shell for battery cells inside the casing. As is further explained herein, according to the illustrated embodiments, each layer L1, L2, L3, L4 of battery cells comprises a number of battery modules, wherein each battery module comprises a number of battery cells arranged in rows. Thus, according to the illustrated embodiments, the casing 7 is configured to support these battery modules.

Like the embodiments illustrated in FIGS. 2 and 3, the casing 7 is formed by a number of casing sections 7.1-7.4 attached to each other via a number of fastening elements, wherein each casing section 7.1-7.4 is configured to accommodate one layer L1-L4 of battery cells.

According to the embodiments illustrated in FIG. 4, a first casing section 7.1 and a first layer L1 of battery cells, as well as a second casing section 7.2 and a second layer L1 of battery cells, of the battery pack 1″ is shorter in length, measured in a direction parallel to the horizontal direction hd, than a third and a fourth casing section 7.3, 7.4 and a third and a fourth layer L3, L4 of battery cells of the battery pack 1″.

In FIG. 4, the vertical direction vd, the longitudinal direction ld, and the horizontal direction hd of the vehicle 2 illustrated in FIG. 1 are indicated. The battery pack 1″ is illustrated in an intended mounting orientation relative to these directions vd, ld, hd in FIG. 4.

According to the embodiments illustrated in FIG. 4, the battery cells of the second, third and fourth layers L2, L3, L4 of battery cells of the battery pack 1″ are electrically connected by electrical connection arrangements arranged inside the casing 7. According to the illustrated embodiments, these electrical connection arrangements can be accessed via a lid arrangement 48 arranged on each of the second, third and fourth casing section 7.2, 7.3, 7.4.

The battery pack 1″ illustrated in FIG. 4 comprises a battery junction compartment 9′. The battery junction compartment 9′ is arranged outside of the casing 7. The feature that the battery junction compartment 9′ is arranged outside of the casing 7 means that the battery junction compartment 9′ is arranged outside of a volume enclosed by the casing 7 and/or by the casing sections 7.1-7.4 thereof.

According to the illustrated embodiments, the battery pack 1″ according to the embodiments illustrated in FIG. 4 comprises a battery junction compartment 9′ having the same design, features, functions, and advantages as the battery junction compartment 9′ of the battery pack 1′ according to the embodiments illustrated in FIG. 3, as is further explained herein. The battery junction compartment 9′ of the battery pack 1″ illustrated in FIG. 4 comprises a number of electrical connection arrangements electrically connecting battery cells of the first and second layers L1, L2 of battery cells of the battery pack 1″.

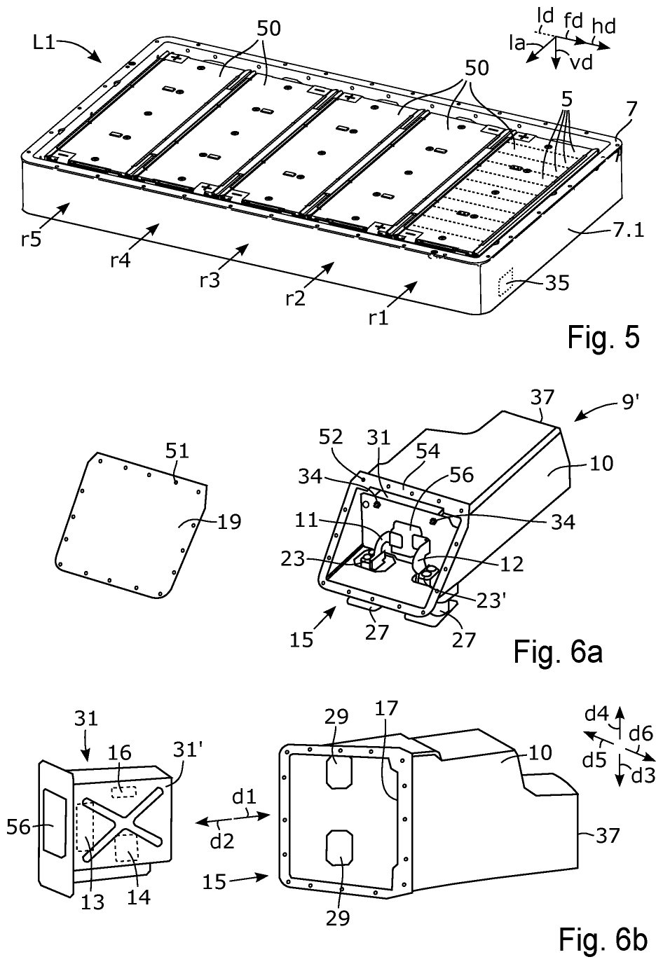

FIG. 5 schematically illustrates a perspective view of the first casing layer 7.1 of the battery pack 1, 1′ according to the embodiments illustrated in FIG. 2 and FIG. 3. Moreover, in FIG. 5, the first Layer L1 of battery cells 5 can be seen.

In FIG. 5, the longitudinal direction ld, the horizontal direction hd, the vertical direction vd, and a lateral direction la of the vehicle 2 illustrated in FIG. 1 are indicated. The lateral direction ld is perpendicular to the vertical direction vd and is perpendicular to the longitudinal direction ld. The first casing layer 7.1 is illustrated in an intended mounting orientation relative to these directions vd, ld, hd, la in FIG. 5.

According to the illustrated embodiments, the first layer L1 of battery cells 5 comprises a number of battery modules 50 arranged adjacent to each other along the horizontal direction hd. In more detail, according to the illustrated embodiments, the battery modules 50 are arranged adjacent to each other along the longitudinal direction ld of the vehicle 2 illustrated in FIG. 1.

According to the embodiments illustrated in FIG. 5, the first layer L1 of battery cells 5 comprises five battery modules 50 arranged adjacent to each other along the lateral direction ld. According to further embodiments, the first layer L1 of battery cells 5 may comprise another number of battery modules 50, such as a number between one and twelve, or a number between one and eight.

Each module 50 comprises one row r1-r5 of battery cells 5. In FIG. 5, only the battery cells 5 of a first row of battery cells 5 are indicated for reasons of brevity and clarity. The battery cells 5 may be lithium-ion battery cells, lithium polymer battery cells, or other types of rechargeable battery cells.

According to the illustrated embodiments, each module 50 comprises a row r1-r5 of eleven battery cells 5. According to further embodiments, each module 50 may comprise another number of battery cells 5, such as a number between two and twenty, or a number between six and twelve. According to the illustrated embodiments, the battery cells 5 of a row r1-r5 of battery cells 5 are arranged adjacent to each other along the lateral direction la.

According to the illustrated embodiments, the battery cells 5 of the rows r1-r5 of battery cells 5 are electrically connected in series with each other. In other words, according to the illustrated embodiments, the battery cells 5 of the modules 50 are electrically connected in series with each other. Moreover, according to the illustrated embodiments, the modules 50 of the first layer L1 are electrically connected in series with each other by electrical connection arrangements arranged inside the first casing section 7.1 of the casing 7. According to further embodiments, two or more of the battery cells 5 in one row r1-r5 of battery cells 5 may be electrically connected in parallel with each other. Likewise, two of more of the modules 50 of the first layer L1 may be electrically connected in parallel with each other, for example by electrical connection arrangements arranged inside the first casing section 7.1 of the casing 7.

According to the embodiments of the battery pack 1, 1′ illustrated in FIGS. 2 and 3, each layer L1-L4 of the respective battery pack 1, 1′ comprises the same number of battery cells 5, modules 50, and rows r1-r5 of battery cells 5 as the first layer L1 of battery cells 5 depicted in FIG. 5. Moreover, the battery cells 5 of each layer L1-L4 of the respective battery pack 1, 1′ may be electrically connected to each other in the same or similar manner as described above.

According to the embodiments of the battery pack 1″ illustrated in FIG. 4, the third and fourth layer L3, L4 of the battery pack 1″ comprises the same number of battery cells 5, modules 50, and rows r1-r5 of battery cells 5 as the first layer L1 of battery cells 5 depicted in FIG. 5. Moreover, the third and fourth layer L3, L4 of battery cells 5 of the battery pack 1″ may be electrically connected to each other in the same or similar manner as described above. However, according to the embodiments of the battery pack 1″ illustrated in FIG. 4, the first and second layer L1, L2 of the battery pack 1″ comprises a smaller number of battery cells 5 than the first layer L1 of battery cells 5 depicted in FIG. 5.

Thus, in summary, according to embodiments herein, each layer L1-L4 of battery cells 5 comprises a number of battery modules 50 arranged adjacent to each other, and wherein each module 50 comprises one row r1-r5 of battery cells 5.

However, according to further embodiments, the battery cells 5, the rows r1-r5 of battery cells 5, and/or the layers L1-L4 of battery cells 5 of a battery pack 1, 1′, 1″ as described herein may be arranged in another manner than described above and may be oriented in another manner relative to the longitudinal direction ld, the forward moving direction fd, the horizontal direction hd, the vertical direction vd, and the lateral direction la than described above. Moreover, according to some embodiments, the battery pack 1, 1′, 1″ as described herein may lack battery modules 50. Instead, the battery pack 1, 1′, 1″ may comprise battery cells 5 arranged adjacent to each other inside a respective casing section 7.1-7.4 to form a respective layer L1-L4 of battery cells 5.

The wording layer L1-L4 of battery cells 5, as referred to herein, means that the battery cells 5 are arranged in such a manner in each layer L1-L4 such that a line through the layer L1-L4 crosses only one battery cell 5 when the line is parallel to one extension direction of the layer L1-L4, namely the vertical direction vd according to the illustrated embodiments, and such that the line crosses several battery cells 5 when the line is parallel to another extension direction of the layer L1-L4, namely one of the horizontal direction hd and the lateral direction la according to the illustrated embodiments.

FIG. 6a schematically illustrates the battery junction compartment 9′ of the battery pack 1′, 1″ according to the embodiments illustrated in FIG. 3 and FIG. 4. As is further explained herein, the battery junction compartment 9′ comprises a number of electrical connection arrangements 11, 12, 31 electrically connecting battery cells 5 of the at least two layers L1-L4 of battery cells 5.

The battery junction compartment 9′ comprises a compartment body 10 and a lid 19. The compartment body 10 forms an opening 15. The lid 19 is arrangeable to cover the opening 15. In FIG. 6a, the lid 19 is illustrated as removed from the opening 15. According to the illustrated embodiments, the lid 19 is arrangeable to the opening by a number of fastening elements, such as screw or bolts, extending through through-holes 51 in the lid 19 into holes 52 in a flange 54 of the compartment body 10.

In FIGS. 3 and 4, the lid 19 is illustrated as attached to the compartment body by a number of fastening elements 53. According to further embodiments, the lid 19 of the battery junction compartment 9′ may be arrangeable to cover the opening 15 in another manner. Moreover, the battery junction compartment 9′ may comprise a sealing arranged around the opening 15 to prevent moisture and matter to enter an inside of the battery junction compartment 9′ via the interface between the flange 54 and the lid 19 when the lid 19 is attached to the flange 54.

According to the illustrated embodiments, when the lid 19 is attached to the compartment body 10 by the number of fastening elements 53 to cover the opening 15, the lid 19 is removably attached thereto to provide access to an inner space of battery junction compartment 9′ via the opening 15 by a removal of the number of fastening elements 53 and the lid 15 from the opening 15. According to further embodiments, the lid 19 may be removably attached or arranged to the compartment body 10 to provide access to an inner space of battery junction compartment 9′ via the opening 15 by removing the lid 19 from the opening 15 of the compartment body 10 in another manner. For example, according to some embodiments, the lid 19 is hinged to the compartment body 10 such that the lid 19 can be pivoted between a closed position, in which the lid 19 covers the opening 15, and an open position in which the lid 19 does not cover the opening 15 to thereby provide access to an inner space of battery junction compartment 9′ via the opening 15. According to such embodiments, as well as other embodiments explained herein, the lid 19 may be lockable in the closed position by a locking mechanism, by one or more fastening elements, or the like.

According to the illustrated embodiments, the number of electrical connection arrangements 11, 12, 31 comprises a component cluster unit 31. In FIG. 6a, the component cluster unit 31 is illustrated as assembled inside the compartment body 10 of the battery junction compartment 9′.

FIG. 6b schematically illustrates the compartment body 10 and the component cluster unit 31 of the battery junction compartment 9′ illustrated in FIG. 6a. In FIG. 6b, the component cluster unit 31 has been removed from an inner space 17 of the battery junction compartment 9′.

That is, according to the illustrated embodiments, the compartment body 10 forms the opening 15 and the inner space 17. Below, simultaneous reference is made to FIG. 1, FIG. 3-FIG. 6b, if not indicated otherwise. The inner space 17 of the compartment body 10 is configured to accommodate a number of electrical connection arrangements 31, 11, 12, 13, 14 for electrically connecting two layers L1-L2 of battery cells 5 of a battery pack 1′, 1″.

That is, in more detail, according to the embodiments illustrated in FIG. 3, the battery junction compartment 9′ accommodates a number of electrical connection arrangements 31, 11, 12, 13, 14 electrically connecting the two layers L1, L2 of battery cells 5 of the battery pack 1′, i.e. the first and second layers L1, L2 of battery cells 5 of the battery pack 1′.

Likewise, according to the embodiments illustrated in FIG. 4, the battery junction compartment 9′ accommodates a number of electrical connection arrangements 31, 11, 12, 13, 14 electrically connecting the first and second layers L1, L2 of battery cells 5 of the battery pack 1″. However, in these embodiments, the battery cells 5 of the second, third and fourth layers L2, L3, L4 of battery cells of the battery pack 1″ are electrically connected to each other by electrical connection arrangements arranged inside the casing 7, as explained with reference to FIG. 4 above.

In both embodiments, the first and second layers L1, L2 of battery cells 5 of the battery pack 1′, 1″ may be electrically connected in series or in parallel inside the battery junction compartment 9′ by the number of electrical connection arrangements 31, 11, 12, 13, 14.

As is indicated in FIG. 6b, according to the illustrated embodiments, at least part of the number of electrical connection arrangements 13, 14 are arranged in the component cluster unit 31 in the form of a battery fuse 13 and a contactor 14. Moreover, as is indicated in FIG. 6a, the number of electrical connection arrangements 31, 11, 12 comprises two electrical connectors 11, 12. The two electrical connectors 11, 12 can be said to be comprised in the component cluster unit 31.

The battery fuse 13 and the contactor 14 are schematically indicated in FIG. 6b in dashed lines. The component cluster unit 31 may comprise more than one contactor 14 and more than one battery fuse 13. The battery fuse 13 is configured to provide overcurrent protection. The battery fuse 13 may for example comprise a melt fuse, a pyro fuse, an electronic fuse, or another type of current breaking device for providing overcurrent protection.

As is indicated in FIG. 6a and FIG. 6b, the battery junction compartment 9′ comprises a high voltage connection arrangement 37 for connecting the layers L1-L4 of battery cells 5 to an electric system 40 of the vehicle 2. The contactor 14, or the number of contactors, can be used to electrically connect and disconnect the layers L1-L4 of battery cells 5 to/from the electric system 40 of the vehicle 2.

According to the illustrated embodiments, the component cluster unit 31 further comprises a battery control arrangement 16. The battery control arrangement 16 may be configured to control the layers L1-L4 of battery cells 5 of the respective battery pack 1′, 1″ illustrated in FIG. 3 and FIG. 4.

As understood from the above, each of the battery fuse 13 and the contactor 14 is arranged to operate in a high voltage electric system wherein the battery control arrangement 16 may operate in a low voltage electric system. Thus, according to embodiments herein, the component cluster 31 unit may comprise high voltage components and systems as well as low voltage components and systems.

The battery junction compartment 9′ comprises a pair of apertures 29. Each aperture 29 of the pair of apertures 29 is configured to accommodate an electrical conductor 27 to a layer L1, L2 of battery cells 5. Moreover, as is seen in FIG. 5, the first casing section 7.1 of the casing 7 comprises an aperture 35. According to embodiments herein, the second casing section 7.2 of the battery pack 1′, 1″ according to the embodiments illustrated in FIG. 3 and FIG. 4 comprises a corresponding aperture, as the aperture 35 of the first casing section 7.1 illustrated in FIG. 5. The electrical conductors 27, indicated in FIG. 6b is configured to protrude into a respective layer L1, L2 of battery cells 5 via a respective aperture 35 in the first and second casing sections 7.1, 7.2 to obtain an electrical connection between the layer L1, L2 of battery cells 5 and the component cluster unit 31 arranged inside the battery junction compartment 9′.

As seen in FIG. 6a, the number of electrical connection arrangements 11, 12, 31 comprises two electrical connectors 11, 12 each connected to a respective electrical conductor 27. Moreover, each of the two electrical connectors 11, 12 is electrically connected to the component cluster unit 31 in a connection interface 56 of the component cluster unit 31.

According to embodiments herein, at least one of the electrical connectors 11, 12 is removably arranged via an attachment assembly 23, 23′, However, as seen in FIG. 6a, according to the illustrated embodiments, each of the two electrical connectors 11, 12 is removably arranged via a respective attachment assembly 23, 23′. As can be seen in FIG. 6a, the attachment assemblies 23, 23′ are accessible via the opening 15 when the lid 19 is removed from the opening 15. In this manner, one or both of the two electrical connectors 11, 12 can be removed in a quick and simple manner to electrically disconnect the component cluster unit 31 from one or both of the first and second layers L1, L2 of the battery pack 1′, 1″ according to the embodiments illustrated in FIG. 3 and FIG. 4. Accordingly, such an electrical disconnection can be performed in a simple and quick manner simply by removing the lid 19 and removing one or both of the two electrical connectors 11, 12 using the respective attachment assembly 23, 23′.

According to the illustrated embodiments, the component cluster unit 31 is assembled inside the inner space 17 of the battery junction compartment 9′ by an insertion of the component cluster unit 31 through the opening 15 along a determined insertion direction d1. The determined insertion direction d1 is indicated in FIG. 6b.

As is indicated in FIG. 6a, the component cluster unit 31 is secured to the compartment body 10 in directions d1, d2 parallel to the determined insertion direction d1 by a number of fastening elements 34. The fastening elements 34 may comprise screws, nuts, bolts, or the like. In FIG. 6a, two fastening elements 34 can be seen. However, the component cluster unit 31 may be secured to the compartment body 10 by another number of fastening elements 34. According to some embodiments, the component cluster unit 31 is secured to the compartment body 10 in directions d1, d2 parallel to the determined insertion direction d1 by four fastening elements 34, wherein each of the four fastening elements 34 is arranged at one corner of the component cluster unit 31.

According to some embodiments, the battery junction compartment 9′ may lack any further fastening elements for securing the component cluster unit 31 to the compartment body 10 than the number of fastening elements 34 arranged to secure the component cluster unit 31 to the compartment body 10 in directions d1, d2 parallel to the determined insertion direction d1.

As indicated in FIG. 6b, the component cluster unit 31 comprises a unit body 31′. According to some embodiments, the component cluster unit 31 may be secured relative to the compartment body 10 in directions d3-d6 transversal to the determined insertion direction d1 by an abutting contact between the unit body 31′ and the compartment body 10. Moreover, according to some embodiments, the compartment body 10 of the battery junction compartment 9′, and/or the component cluster unit 31, may comprise one or more resilient elements, such as rubber pads, or the like, in the interface between the compartment body 10 and the component cluster unit 31 to support the component cluster unit 31 relative to the compartment body 10 in directions d3-d6 transversal to the determined insertion direction d1.

As an alternative, or in addition, a back wall of the inner space 17 of the battery junction compartment 9′ may comprise a protrusion configured to protrude into a recess of the unit body 31′ of the component cluster unit 31 when the component cluster unit 31 is assembled inside the inner space 17 of the battery junction compartment 9′.

In this manner, the component cluster unit 31 can be secured relative to the compartment body 10 in directions d3-d6 transversal to the determined insertion direction d1 without the need further fastening elements for securing the component cluster unit 31 to the compartment body 10 than the number of fastening elements 34 arranged to secure the component cluster unit 31 to the compartment body 10 in directions d1, d2 parallel to the determined insertion direction d1. Moreover, the component cluster unit 31 can be assembled in the inner space 17 of the battery junction compartment 9′ and the fastening elements 34 can be secured from the same side of the battery junction compartment 9′. As a result, a battery pack 1′, 1″ is provided having conditions and characteristics suitable for being manufactured and assembled in a cost-efficient manner. Moreover, a battery pack 1′, 1″ is provided significantly facilitating maintenance, service, repair, and replacements of components of the battery pack 1′, 1″.

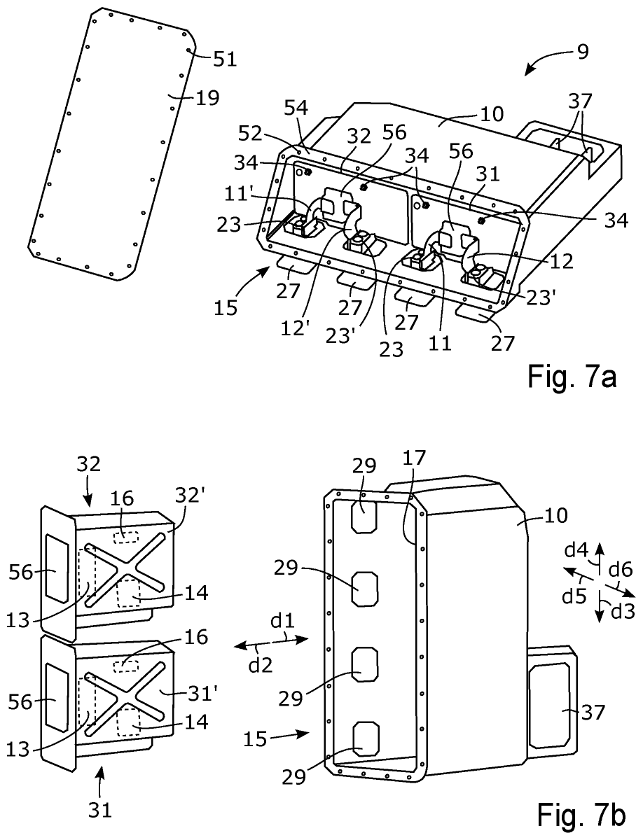

FIG. 7a schematically illustrates the battery junction compartment 9 of the battery pack 1 according to the embodiments illustrated in FIG. 2. Below, simultaneous reference is made to FIG. 2, FIG. 5, and FIG. 7a, if not indicated otherwise. As is further explained herein, the battery junction compartment 9 comprises a number of electrical connection arrangements 11, 12, 31, 11′, 12′, 32 electrically connecting battery cells 5 of the four layers L1-L4 of battery cells 5 of the battery pack 1.

The battery junction compartment 9 comprises a compartment body 10 and a lid 19. The compartment body 10 forms an opening 15. The lid 19 is arrangeable to cover the opening 15. In FIG. 7a, the lid 19 is illustrated as removed from the opening 15. According to the illustrated embodiments, the lid 19 is arrangeable to the opening 15 by a number of fastening elements, such as screw or bolts, extending through through-holes 51 in the lid 19 into holes 52 in a flange 54 of the compartment body 10.

In FIG. 2, the lid 19 is illustrated as attached to the compartment body by a number of fastening elements 53. According to further embodiments, the lid 19 of the battery junction compartment 9 may be arrangeable to cover the opening 15 in another manner, such as in a manner explained with reference to FIG. 6a above. Moreover, the battery junction compartment 9 may comprise a sealing arranged around the opening 15 to prevent moisture and matter to enter an inside of the battery junction compartment 9 via the interface between the flange 54 and the lid 19 when the lid 19 is attached to the flange 54.

As explained above, the battery pack 1 according to the embodiments illustrated in FIG. 2 comprises four layers L1-L4 of battery cells 5. The battery junction compartment 9 according to the embodiments illustrated in FIG. 7a comprises a first component cluster unit 31 comprising electrical connection arrangements 11, 12, 31 electrically connecting battery cells 5 of a first pair of layers L1, L2 of battery cells 5, and a second component cluster unit 32 comprising electrical connection arrangements 11′, 12′, 32 electrically connecting battery cells 5 of a second pair of layers L3, L4 of battery cells 5.

In other words, according to these embodiments, the battery junction compartment 9 comprises one component cluster unit 31, 32 per pair of layers L1-L4 of battery cells 5, and wherein each component cluster unit 31, 32 comprises electrical connection arrangements 11, 12, 11′, 12′, 31, 32 electrically connecting battery cells 5 of one pair of layers L1, L2, L3, L4 of battery cells 5.

According to the illustrated embodiments, the second component cluster unit 32 has the same design, layout, and types of components as the first component cluster unit 31. Moreover, each of the first and second component cluster units 31, 32 may comprise the same features, functions, and advantages as the component cluster unit 31 explained with reference to FIG. 6a and FIG. 6b above.

In FIG. 7a, each of the first and second component cluster units 31, 32 is illustrated as assembled inside the compartment body 10 of the battery junction compartment 9.

FIG. 7b schematically illustrates the compartment body 10 and the first and second component cluster units 31, 32 of the battery junction compartment 9 illustrated in FIG. 7a. In FIG. 7b, the first and second component cluster units 31, 32 have been removed from an inner space 17 of the battery junction compartment 9.

That is, according to the illustrated embodiments, the compartment body 10 forms the opening 15 and the inner space 17. Below, simultaneous reference is made to FIG. 1, FIG. 2, FIG. 5, FIG. 7a, and FIG. 7b, if not indicated otherwise. The inner space 17 of the compartment body 10 is configured to accommodate a number of electrical connection arrangements 11, 12, 11′, 12′, 31, 32, 13, 14 for electrically connecting four layers L1-L4 of battery cells 5 of a battery pack 1.

The four layers L1-L4 of battery cells 5 of the battery pack 1 may be electrically connected in series with each other inside the battery junction compartment 9 by the number of electrical connection arrangements 11, 12, 11′, 12′, 31, 32, 13, 14. As an alternative, two or more of the four layers L1-L4 of battery cells 5 of the battery pack 1 may be electrically connected in parallel with each other inside the battery junction compartment 9 by the number of electrical connection arrangements 11, 12, 11′, 12′, 31, 32, 13, 14.

According to the illustrated embodiments, each of the first and second component cluster units 31, 32 comprises the same features, functions, and advantages as the component cluster unit 31 explained with reference to FIG. 6a and FIG. 6b above. Accordingly, each of the first and second component cluster units 31, 32 comprises a battery fuse 13, a contactor 14, and a battery control arrangement 16. The features and functions of the battery fuse 13 and the contactor 14 are explained with reference to FIG. 6b above. The battery control arrangement 16 may be configured to control the layers L1-L4 of battery cells 5 of the battery pack 1 illustrated in FIG. 2

As is indicated in FIG. 7a and FIG. 7b, the battery junction compartment 9 comprises a high voltage connection arrangement 37 for connecting the layers L1-L4 of battery cells 5 to an electric system 40 of the vehicle 2. The contactor 14, or the number of contactors, can be used to electrically connect and disconnect the layers L1-L4 of battery cells 5 to/from the electric system 40 of the vehicle 2.

According to the embodiments illustrated in FIGS. 7a and 7b, the battery junction compartment 9 comprises one aperture 29 per layer L1-L4 of battery cells 5, wherein each aperture 29 accommodates an electrical conductor 27 to a layer L1-L4 of battery cells 5. Thus, in these embodiments, the battery junction compartment 9 comprises four apertures, wherein each aperture 29 accommodates an electrical conductor 27 to a layer L1-L4 of battery cells 5.

As explained with reference to FIG. 5 above, the first casing section 7.1 of the casing 7 comprises an aperture 35. According to embodiments herein, each of the second, third, and fourth casing sections 7.2, 7.3, 7.4 of the battery pack 1 according to the embodiments illustrated in FIG. 2 comprises a corresponding aperture, as the aperture 35 of the first casing section 7.1 illustrated in FIG. 5. The electrical conductors 27, indicated in FIG. 7b is configured to protrude into a respective layer L1-L4 of battery cells 5 via a respective aperture 35 in the respective casing sections 7.1-7.4 to obtain an electrical connection between the layer L1-L4 of battery cells 5 and the first and second component cluster units 31, 32 arranged inside the battery junction compartment 9.

As seen in FIG. 7a, the number of electrical connection arrangements 11, 12, 11′, 12′, 31, 32 comprises four electrical connectors 11, 12, 11′, 12′ each connected to a respective electrical conductor 27. Moreover, each of the four electrical connectors 11, 12, 11′, 12′ is electrically connected to one component cluster unit 31, 32 in a connection interface 56 of the component cluster unit 31, 32.

According to embodiments herein, at least one of the electrical connectors 11, 12, 11′, 12′ is removably arranged via an attachment assembly 23, 23′, However, as seen in FIG. 7a, according to the illustrated embodiments, each of the four electrical connectors 11, 12, 11′, 12′ is removably arranged via a respective attachment assembly 23, 23′. As can be seen in FIG. 7a, the attachment assemblies 23, 23′ are accessible via the opening 15 when the lid 19 is removed from the opening 15. In this manner, one or all of the four electrical connectors 11, 12, 11′, 12′ can be removed in a quick and simple manner to electrically disconnect a component cluster unit 31, 32 from one or more of the layers L1-L4 of battery cells 5 of the battery pack 1 according to the embodiments illustrated in FIG. 2. Accordingly, such an electrical disconnection can be performed in a simple and quick manner simply by removing the lid 19 and remove one or more of the four electrical connectors 11, 12, 11′, 12′ using the respective attachment assemblies 23, 23′.

According to the embodiments illustrated in FIG. 7a and FIG. 7b, each of the first and second component cluster units 31, 32 is assembled inside the inner space 17 of the battery junction compartment 9 by an insertion of the component cluster unit 31, 32 through the opening 15 along a determined insertion direction d1. The determined insertion direction d1 is indicated in FIG. 7b. As is indicated in FIG. 7a, the component cluster unit 31 is secured to the compartment body 10 in directions d1, d2 parallel to the determined insertion direction d1 by a number of fastening elements 34. The fastening elements 34 may comprise screws, nuts, bolts, or the like. In FIG. 7a, two fastening elements 34 per component cluster unit 31, 32 can be seen. However, each component cluster unit 31, 32 may be secured to the compartment body 10 by another number of fastening elements 34. According to some embodiments, each component cluster unit 31, 32 is secured to the compartment body 10 in directions d1, d2 parallel to the determined insertion direction d1 by four fastening elements 34, wherein each of the four fastening elements 34 is arranged at one corner of the component cluster unit 31, 32.

According to some embodiments, the battery junction compartment 9 may lack any further fastening elements for securing the component cluster unit 31, 32 to the compartment body 10 than the number of fastening elements 34 arranged to secure the component cluster unit 31 to the compartment body 10 in directions d1, d2 parallel to the determined insertion direction d1.

As indicated in FIG. 7b, each component cluster unit 31, 32 comprises a unit body 31′, 32′. According to some embodiments, the component cluster unit 31, 32 may be secured relative to the compartment body 10 in directions d3-d6 transversal to the determined insertion direction d1 by an abutting contact between the unit body 31′, 32′ and the compartment body 10. Moreover, according to some embodiments, the compartment body 10 of the battery junction compartment 9, and/or each component cluster unit 31, 32, may comprise one or more resilient elements, such as rubber pads, or the like, in the interface between the compartment body 10 and the component cluster unit 31, 32 to support the component cluster unit 31, 32 relative to the compartment body 10 in directions d3-d6 transversal to the determined insertion direction d1. As an alternative, or in addition, a back wall of the inner space 17 of the battery junction compartment 9 may comprise protrusions each configured to protrude into a recess of a unit body 31′, 32′ of the respective component cluster unit 31, 32 when the component cluster unit 31, 32 is assembled inside the inner space 17 of the battery junction compartment 9.

In this manner, the component cluster unit 31, 32 can be secured relative to the compartment body 10 in directions d3-d6 transversal to the determined insertion direction d1 without the need further fastening elements for securing the component cluster unit 31, 32 to the compartment body 10 than the number of fastening elements 34 arranged to secure the component cluster unit 31, 32 to the compartment body 10 in directions d1, d2 parallel to the determined insertion direction d1. Moreover, each component cluster unit 31, 32 can be assembled in the inner space 17 of the battery junction compartment 9 and the fastening elements 34 can be secured from the same side of the battery junction compartment 9. As a result, a battery pack 1 is provided having conditions and characteristics suitable for being manufactured and assembled in a cost-efficient manner. Moreover, a battery pack 1 is provided significantly facilitating maintenance, service, repair, and replacements of components of the battery pack 1.

As seen in FIG. 2, FIG. 3, and FIG. 4, the battery pack 1, 1′, 1″ according to each of the illustrated embodiments is attachable to a vehicle such that the battery junction compartment 9, 9′ of the battery pack 1, 1′, 1″ can be accessed from an outside of the vehicle.

Since the layers L1-L4 of battery cells 5 the battery pack 1, 1′, 1″ according to embodiments herein are electrically connected via the number of electrical connection arrangements 11, 12, 11′, 12′, 31, 32 arranged inside the battery junction compartment 9, 9′, the casing 7 of the battery pack 1, 1′, 1″ may lack electrical connection arrangements for electrically connecting the layers L1-L4 of battery cells 5 the battery pack 1, 1′, 1″, which provides several advantages, as explained herein.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A battery pack configured to provide electricity to an electric propulsion motor of a vehicle, wherein the battery pack comprises:
at least two layers of battery cells arranged inside a casing; and
a battery junction compartment arranged outside of the casing,
wherein the battery junction compartment comprises a number of electrical connection arrangements electrically connecting battery cells of the at least two layers of battery cells.

2. The battery pack according to claim 1, wherein the battery junction compartment comprises:
a compartment body forming an opening and an inner space accommodating the number of electrical connection arrangements; and
a lid arrangeable to cover the opening and removable to provide access to the inner space of battery junction compartment via the opening.

3. The battery pack according to claim 1, wherein the number of electrical connection arrangements comprises at least one electrical connector removably arranged via an attachment assembly.

4. The battery pack according to claim 2, wherein the attachment assembly is accessible via the opening when the lid is removed from the opening.

5. The battery pack according to claim 1, wherein the number of electrical connection arrangements comprises one or more of a battery fuse and a contactor.

6. The battery pack according to claim 1, wherein the battery junction compartment comprises a component cluster unit comprising at least part of the number of electrical connection arrangements.

7. The battery pack according to claim 6, wherein the component cluster unit further comprises a battery control arrangement.

8. The battery pack according to claim 6, wherein the battery junction compartment comprises a compartment body forming an opening and an inner space accommodating the number of electrical connection arrangements, wherein the component cluster unit is assembled inside the inner space by an insertion of the component cluster unit through the opening along a determined insertion direction, and wherein the component cluster unit is secured to the compartment body in directions parallel to the determined insertion direction by a number of fastening elements.

9. The battery pack according to claim 8, wherein the component cluster unit comprises a unit body, and wherein the component cluster unit is secured relative to the compartment body in directions transversal to the determined insertion direction by an abutting contact between the unit body and the compartment body.

10. The battery pack according to claim 1, wherein the battery junction compartment comprises one component cluster unit per pair of layers of battery cells of the battery pack, and wherein each component cluster unit comprises electrical connection arrangements electrically connecting battery cells of one pair of layers of battery cells.

11. The battery pack according to claim 1, wherein the battery pack comprises at least four layers of battery cells, and wherein the battery junction compartment comprises a first component cluster unit comprising electrical connection arrangements electrically connecting battery cells of a first pair of layers of battery cells, and a second component cluster unit comprising electrical connection arrangements electrically connecting battery cells of a second pair of layers of battery cells.

12. The battery pack according to claim 11, wherein the second component cluster unit has the same design, layout, and types of components as the first component cluster unit.

13. The battery pack according to claim 1, wherein the battery junction compartment comprises a high voltage connection arrangement for connecting the layers of battery cells to an electric system of the vehicle.

14. A vehicle comprising:
an electric propulsion motor configured to provide motive power to the vehicle; and
a battery pack configured to provide electricity to the electric propulsion motor, wherein the battery pack comprises:
at least two layers of battery cells arranged inside a casing; and
a battery junction compartment arranged outside of the casing,
wherein the battery junction compartment comprises a number of electrical connection arrangements electrically connecting battery cells of the at least two layers of battery cells.

15. The vehicle according to claim 14, wherein the battery pack is attached to the vehicle such that the battery junction compartment of the battery pack can be accessed from an outside of the vehicle.

16. The battery pack according to claim 14, wherein the battery junction compartment comprises:
a compartment body forming an opening and an inner space accommodating the number of electrical connection arrangements; and
a lid arrangeable to cover the opening and removable to provide access to the inner space of battery junction compartment via the opening.

17. The battery pack according to claim 14, wherein the battery junction compartment comprises:
a component cluster unit comprising at least part of the number of electrical connection arrangements; and
a compartment body forming an opening and an inner space accommodating the number of electrical connection arrangements, wherein the component cluster unit is assembled inside the inner space by an insertion of the component cluster unit through the opening along a determined insertion direction, and wherein the component cluster unit is secured to the compartment body in directions parallel to the determined insertion direction by a number of fastening elements.

18. The battery pack according to claim 17, wherein the component cluster unit comprises a unit body, and wherein the component cluster unit is secured relative to the compartment body in directions transversal to the determined insertion direction by an abutting contact between the unit body and the compartment body.

19. The battery pack according to claim 14, wherein the battery junction compartment comprises one component cluster unit per pair of layers of battery cells of the battery pack, and wherein each component cluster unit comprises electrical connection arrangements electrically connecting battery cells of one pair of layers of battery cells.

20. The battery pack according to claim 14, wherein the battery pack comprises at least four layers of battery cells, and wherein the battery junction compartment comprises a first component cluster unit comprising electrical connection arrangements electrically connecting battery cells of a first pair of layers of battery cells, and a second component cluster unit comprising electrical connection arrangements electrically connecting battery cells of a second pair of layers of battery cells.
